(19) United States
(12) Patent Application Publication
(10) Pub. No.: US 2021/0097549 A1
(43) Pub. Date: Apr. 1, 2021

(54) METHODS, SYSTEMS AND COMPUTER PROGRAM PRODUCTS FOR OPTIMIZING ELECTRONIC DIRECT BENEFIT TRANSFERS

(71) Applicant: MASTERCARD INTERNATIONAL INCORPORATED, Purchase, NY (US)

(72) Inventors: Arnab MOITRA, Kolkata (IN); Gagandeep SINGH, Pune (IN); Neha CHADHA, Pune (IN); Paul BAKER, Shipley (GB); John STRAIN, Dublin (IE)

(73) Assignee: MASTERCARD INTERNATIONAL INCORPORATED, Purchase, NY (US)

(21) Appl. No.: 16/997,790

(22) Filed: Aug. 19, 2020

(30) Foreign Application Priority Data
Sep. 26, 2019 (IN) 201911038941

(51) Int. Cl. G06Q 20/40; G06Q 40/02; G06Q 40/00

(52) U.S. Cl. CPC G06Q 20/40145; G06Q 40/125; G06Q 40/02

(57) ABSTRACT

The disclosure provides methods, systems and computer program products that enable optimized direct benefit transfers from an originator to a beneficiary. Implementation of a direct benefit transfer involves receiving from an originator bank server a user identifier uniquely associated with the beneficiary, and direct benefit transfer payment amount. The user identifier is used to retrieve a payment account identifier associated with the beneficiary. The retrieved identifiers are used to route the payment account identifier and the transaction amount information to a beneficiary bank server that is identified. The beneficiary bank server responds to credit of the disbursement amount, by crediting the payment account associated with the beneficiary.

### CROSS-REFERENCE TO RELATED APPLICATIONS

This application claims priority to Indian Application Serial No. 201911038941, filed Sep. 26, 2019, which is incorporated herein by reference in its entirety. This application is related to PCT application no. PCT/US20/046615, filed on Aug. 17, 2020, which also claims priority to Indian Application Serial No. 201911038941.

### TECHNICAL FIELD

The present disclosure relates to electronic payment transactions. The disclosure provides methods, systems and computer program products that enable direct benefit transfers involving electronic remittance of benefit payments from a disbursing entity (for example, a government department, administrative department or any corporate or financial department) to electronic payment accounts of one or more beneficiaries.

### BACKGROUND

Direct benefit transfer refers to a process of electronically transferring subsidies or other financial benefits from a disbursing entity (for example, a government entity or department, an administrative department or any corporate or financial department), to one or more intended beneficiaries—wherein the transfer of funds occurs electronically and directly between bank account(s) associated with the government entity or department, and beneficiary bank accounts. The objective of implementing direct benefit transfer is to reduce delays in delivering the payment benefits, eliminate revenue leaks and revenue pilferage, and to improve traceability of disbursed funds and consequently, financial accountability.

An existing system for direct benefit transfer has been implemented in India—based on the Government of India's Unique Identification Authority of India (UIDAI)'s Aadhar program. The UIDAI program allocates a unique UIDAI ID to each individual enrolled with the program—and implements systems that enable secure verification of the identity of such individual, each time the individual's unique UIDAI number is used for the purposes of identity verification. The existing system for direct benefit transfer within India, has been implemented by the National Payments Corporation of India (NPCI)—and is described briefly to explain the technical problems that the present disclosure seeks to address.

FIG. 1 illustrates an existing system environment 100 set up by the NPCI through which electronic payments can be made from a payor bank to a payee bank. System environment 100 comprises an originator bank 102, beneficiary bank 104, and NPCI payment platform 106. Each of originator bank 102, and beneficiary bank 104 are configured for network-based data communication with NPCI payment platform 106 through one or more communication networks 110, 110′.

Originator bank 102 is a bank at which the disbursing entity (i.e. government department or other entity) responsible for initiating a direct benefit transfer payment, holds an electronic payment account. Beneficiary bank 104 is a bank at which an intended beneficiary of the direct benefit transfer payment holds an electronic payment account.

The NPCI payment platform 106 comprises payment platform server 106a, payment platform gateway interface 106b and payment platform database 106c. Payment platform server 106a may be configured to perform clearinghouse and/or settlement related functions to enable fund transfers between accounts maintained at originator bank 102 and accounts maintained at beneficiary bank 104. Payment platform server 106a may comprise at least one processor, and one or more transitory and/or non-transitory memories. Payment platform gateway interface 106b may include a hardware or software network gateway configured to enable transmission and receipt of communications by payment platform server 106a. Payment platform database 108c may comprise a non-transitory memory based database, configured to store data records corresponding to users and electronic payments accounts that are onboarded with NPCI payment platform 106, and/or data records corresponding to electronic payment transactions routed or effected through NPCI payment platform 106.

The way system environment 100 of FIG. 1 is configured to implement direct benefit payment transactions between an originator bank account and a beneficiary bank account, may be understood in accordance with the further implementation details provided below in connection with FIGS. 2 to 7.

FIG. 2 illustrates a system 200 configured to on-board or register a user 202 for availing direct benefit transfers through system environment 100 of FIG. 1. System 200 comprises user 202, terminal device 204, NPCI payment platform 206, beneficiary bank server platform 208, and network 210. Each of terminal device 204, NPCI payment platform 206, and beneficiary bank server platform 208 are communicably coupled with each other through network 210.

Terminal device 204 may comprise any processor implemented network communication enabled device through which a user 202 can initiate and control a process for registration as a beneficiary for direct bank transfer services with NPCI payment platform 206. In the illustrated embodiment, terminal device 204 may comprise any of mobile communication device 204a, computer terminal 204b or server device 204c. NPCI payment platform 206 comprises payment platform server 206a, payment platform gateway interface 206b and payment platform database 206c that have functionality already described in connection with FIG. 1.

Beneficiary bank server platform 208 comprises beneficiary bank server 208a, beneficiary bank gateway interface 208b and beneficiary bank database 208c. Beneficiary bank server 208a may comprise at least one processor, and one or more transitory and/or non-transitory memories—and may be configured to generate, monitor and maintain electronic payment accounts, and to control transfer of funds into and out of such electronic payment accounts. Beneficiary bank gateway interface 208b may include a hardware or software network gateway configured to enable transmission and receipt of network data communications by beneficiary bank server 208a. Beneficiary bank database 208c may comprise a non-transitory memory based database, configured to store data records corresponding to electronic payment accounts maintained at the beneficiary bank, and corresponding to payment transactions involving such electronic payment accounts.

The method by which a user 202 is on-boarded through system 200 as a beneficiary authorized to avail direct benefit transfers, is described in connection with the flowchart of FIG. 3. The method of FIG. 3 assumes that user 202 is already enrolled with an identity verification platform that is configured to store identity information regarding registrants, and which identity information includes (i) at least a unique registrant ID that is uniquely associated with the corresponding registrant, and (ii) additional identity data/metadata corresponding to said registrant. An example of an identity verification platform with which a user 202 may be enrolled for the purposes of the method of FIG. 3 is the UIDAI identity verification platform set up by the Government of India under the UIDAI/Aadhar project, which assigns to each registrant, a unique UIDAI/Aadhar number. In other embodiments, any other government or private sector backed unique identification platform that issues unique identifiers to enrolled individuals—and which unique identifiers can be linked to the corresponding enrolled individual's bank account(s), may also be implemented for the method of FIG. 3. Examples of other such unique identifiers may include driving license IDs, social security number(s), identification number(s) issued by the national taxation/revenue services (for example, a Permanent Account Number (PAN) issued by the Indian Income Tax Department) etc.

The method of FIG. 3 also assumes that user 202 holds a payment account with the beneficiary bank—wherein the user payment account is maintained by beneficiary bank server platform 208.

At 302, user 202 request beneficiary bank server platform 208 to associate or link the user's unique registrant ID (that has been issued by an identity verification platform) with the user's payment account that is maintained by beneficiary bank server platform 208. User 202 may initiate the request through terminal device 204—and the request may be accompanied by the user's unique registrant ID as well as the user's bank account information, which bank account information identifies the beneficiary bank, as well as a payment account number uniquely corresponding to the user's payment account at the beneficiary bank. The request, unique registrant ID and bank account information may be transmitted from terminal device 204 to beneficiary bank server platform 208.

At 304, beneficiary bank server platform 208 verifies that the received bank account information is correct and corresponds to user 202. The verification process may comprise any one or more processes that are well known in the art. In the case of received bank account information, verification may comprise ascertaining the integrity and correctness of the received bank account information, and optionally, ascertaining identity of user 202 through one or more challenge-response type methods based on data records of beneficiary bank server platform 208 Responsive to determining that the received bank account information does in fact correspond to requesting user 202, 304 comprises associating or linking the received unique registrant ID with the user's bank account in the data records of beneficiary bank server platform 208.

Thereafter, 306 comprises beneficiary bank server platform 208 transmitting a beneficiary registration request message to NPCI payment platform 206. The request message transmitted at 306 includes at least the unique registrant ID corresponding to user 202, and a user bank identification number, which uniquely identifies the beneficiary bank at which user 202 holds a payment account.

At 308, NPCI payment platform 206 records an association or link between the received unique registrant ID corresponding to user 202 and the received user bank identification number which uniquely identifies the beneficiary bank. NPCI payment platform stores the unique registrant and user bank identification number, along with information associating the two data elements in payment platform database 206c.

FIG. 7 illustrates an example of a data record structure 700 of a type that is capable of being used for storing the user's unique registrant ID and user bank identification number, in a manner that associates both such data elements, in 308. As shown in FIG. 7, data record structure 700 comprises a first data field 702 for storing a unique registrant ID, and a second data field 704 for storing the bank identification number associated with said unique registrant ID.

FIG. 4 illustrates a communication flow diagram illustrating the communication flow between entities when implementing the method s of FIG. 3.

As shown in FIG. 4, the method commences at 4002, wherein terminal device 204 transmits to beneficiary bank server platform 208, a request to associate or link a user's unique registrant ID with the user's payment account that is maintained or accessible by beneficiary bank server platform 208. It would be understood that transmission of the request from terminal device 204 may be initiated by a user operating or providing input through terminal device 204.

Beneficiary bank server platform 208 verifies the received bank account information. Verification of the received bank account information may include verification the bank account information is correct, as well as verification that a user who has initiated transmission of the request at 4002 is an authorized user in respect of a payment account identified within the received bank account information. Responsive to satisfactory verification of the received bank account information and received unique registrant ID, beneficiary bank server platform associates the received unique registrant ID with the requesting user's bank account, within data records of beneficiary bank server platform 208.

At 4004, beneficiary bank server platform 208 transmits a beneficiary registration request message to NPCI payment platform 206. The request message transmitted at 4004 includes at least the unique registrant ID received at 4002, and a user bank identification number, which uniquely identifies the beneficiary bank.

NPCI payment platform 206 subsequently records an association between the received unique registrant ID and the received user bank identification number, and stores the unique registrant ID and user bank identification number, along with information associating the two data elements, in a database corresponding to NPCI payment platform 206 (for example, in payment platform database 206c).

At 4006, NPCI payment platform 206 transmits a beneficiary registration confirmation message to beneficiary bank server platform 208. At 4008, beneficiary bank server platform 208 in turn transmits a beneficiary registration confirmation message to terminal device 204—which serves to inform the user (who is operating or providing input through terminal device 204) that information corresponding to the user has now been appropriately registered as a beneficiary at the NPCI payment platform 206, to enable direct benefit transfer payments to such user through NPCI payment platform 206.

FIG. 5 illustrates a system environment 500 comprising various entities involved in implementing direct benefit transfer payments within the existing electronic payment infrastructure that has been described above in connection with FIGS. 1 to 4.

System environment 500 comprises originator server 502, originator bank server 504, NPCI payment platform 506, beneficiary bank server platform 508 and beneficiary 510. Originator server 502 is a server associated with and operated and controlled by the government department or other entity responsible for initiating a direct benefit transfer payment. Originator bank server 504 is a server operated or controlled by an originator bank at which the government department or other entity responsible for initiating a direct benefit transfer payment, holds an electronic payment account. NPCI payment platform 506 is the payment platform that has been discussed in detail in connection with FIGS. 1 to 4 above—and comprises at least payment platform server 506a, payment platform gateway interface 506b and payment platform database 506c. Likewise, beneficiary bank server platform 508 may be configured in accordance with embodiments discussed in detail in connection with FIGS. 1 to 4 above—and comprises beneficiary bank server 508a, beneficiary bank gateway interface 508b and beneficiary bank server database 508c. Beneficiary 510 is the intended beneficiary of a direct benefit transfer payment, and holds a payment account maintained by or within beneficiary bank server platform 508.

FIG. 6 illustrates a flowchart describing a method for implementing a direct benefit transfer payment within system environment 500. For the purposes of describing the method of FIG. 6, it would be understood that for implementing a direct beneficiary transfer payment initiated at an originator server 502 and directed to beneficiary 510, said beneficiary has been previously enrolled or registered at both beneficiary bank server platform 508 and NPCI payment platform 506 in accordance with the method of FIG. 3—and that as a result, NPCI payment platform 506 has been updated by recording an association between a unique registrant ID corresponding to beneficiary 510, and a bank identification number associated with beneficiary bank server platform 508 (or associated with a beneficiary bank to which beneficiary bank server platform 508 corresponds). In an embodiment, this association may be recorded within payment platform database 506c within NPCI payment platform 506, through a data record generated based on the data record structure illustrated and described above in connection with FIG. 7.

602 comprises transmitting from originator server 502 to originator bank server 504, a direct benefit transfer payment instruction. The transaction payment instruction comprises or is accompanied by a beneficiary unique registrant ID associated with the intended beneficiary 510, and an indication of the transaction amount.

At 604, originator bank server 504 transmits the transaction instruction to NPCI payment platform 506. The transaction instruction comprises or is accompanied by the beneficiary unique registrant ID associated with the intended beneficiary 510, and the indication of the transaction amount.

At 606, responsive to receiving the transaction instruction, NPCI payment platform 506 retrieves from its data records (for example, data records stored within payment platform database 506c), a beneficiary bank identification number that is associated with the beneficiary unique registrant ID that has been received at 604.

At 608, NPCI payment platform 506 transmits the transaction amount information and beneficiary unique registrant ID to a beneficiary bank server platform 508 that corresponds to a beneficiary bank identified by the beneficiary bank identification number retrieved at 606.

Thereafter at 610, NPCI payment platform 506 initiates transaction settlement with the identified beneficiary bank—which transaction settlement includes crediting to the identified beneficiary bank, a payment amount that includes the transaction amount corresponding to the direct benefit transfer payment initiated at 602 by originator server 502.

At 612, beneficiary bank server 508a (within beneficiary bank server platform 508) retrieves from beneficiary bank server database 508c, a beneficiary bank account number that is associated or linked (within the data records of the beneficiary bank) with the unique registrant ID received from the NPCI payment platform 608.

At 614, beneficiary bank server 508a credits to a beneficiary bank account corresponding to the beneficiary bank account number retrieved at 612, the transaction amount corresponding to the direct benefit transfer payment initiated at 602 by originator server 502.

The prior art solution for direct benefit transfers that relies on the NPCI payment platform described above has multiple drawbacks.

A principal drawback is a lack of network communication efficiency—inasmuch that enrolling a beneficiary within the system to enable such beneficiary to receive direct benefit transfer payments, requires data records at both the beneficiary bank platform and the NPCI server platform to be updated. Keeping in mind the issue of network latency, data messaging round-trip overheads, and differing load handling capabilities of beneficiary bank server(s) and the payment platform server(s), it would be understood that a system that requires generation or update of data records at both of the beneficiary bank platform and the NPCI server platform, would involve slower response times, and higher network communication overheads. Additionally, network or server failure at either of the NPCI server platform and the beneficiary result in a complete interruption to the process of enrolling a beneficiary into the system, and would result in subsequent failure of the direct benefit transfer process to such beneficiary.

Likewise, the process of initiating a direct benefit transfer from an originating server to a beneficiary bank account, requires multiple retrievals of data records from at least two different platforms to correctly route the payment transaction. A first stage look-up is required at the NPCI payment platform, where a bank identification number is retrieved based on the UIDAI ID of an intended beneficiary. A second stage look-up is required at a bank server corresponding to a beneficiary bank associated with the retrieved bank identification number—wherein the second stage look-up involves retrieval of a beneficiary bank account number identifying a payment account to which the direct benefit transfer payment requires to be credited. This multiple stage look-up further increases the network communication overhead, round-trip data messaging time required for transaction implementation, and the likely points of failure.

Additionally, the existing system also increases data and communication overheads as a result of the requirement to maintain data integrity between the beneficiary bank server platform and the NPCI payment platform. Further, there is a significant increase in failure rate where such data integrity is not maintained.

The prior art system also does not enable dynamic or instance specific routing of payment transactions among a plurality of bank accounts associated with a single beneficiary.

In the prior art solution, the beneficiary cannot select a destination account from among a plurality of banks or bank accounts, for receiving a direct benefit transfer payment—since identification of a bank account associated with the beneficiary only occurs after the transaction intimation is sent to a bank associated with the beneficiary's UIDIA ID in the records of the NPCI payment platform.

In addition to the above, the prior art solutions also present the following drawbacks:
Since the unique registrant ID at the NPCI payment platform is only mapped to a bank identification number, the prior art solution requires to perform a second stage mapping at the destination bank to identify a bank account number/identifier associated with the unique registrant ID. This second stage mapping increases the network overhead and the processing overheads for the destination bank.
Current implementations of the NPCI payment platform only support a single type of unique registrant ID i.e. the UIDAI ID/Aadhaar number.
In practice, only the bank account that is most recently linked with a unique registrant ID in the records of the NPCI payment platform is used as a destination for direct benefit transfer payments through the NPCI payment platform.
Registration of a beneficiary at the NPCI payment platform can only be effected through the destination bank, since the registration requires registration of the beneficiary's unique registrant ID at the destination bank as well as at the NPCI payment platform.
Verification of the unique registrant ID is not undertaken prior to registering an individual as a new beneficiary within the NPCI payment platform—which increases the risk of payment transaction errors and/or identity fraud.
Since beneficiary registration at the NPCI payment platform involves registration of the unique registrant ID at the destination bank and at the NPCI payment platform, failure to maintain data integrity between the two gives rise to the risk of transaction failure.
The prior art systems involving the NPCI payment platform relies on file based National Automated Clearinghouse (NACH) solutions for settlement and clearance—which routinely requires multiple days for payment clearance.
The prior art systems do not support identification of ineligible beneficiaries through periodic review of data records.
The prior art systems have also been found to increase reconciliation effort for banks during the registration and payment processes.

There is accordingly a need for optimizing the existing systems for direct benefit transfer payments, to reduce communication overhead, network latency, network communication failure rates and transaction failure rates. There is additionally a need to enable transaction route switching between multiple beneficiary bank servers in the event a beneficiary has a plurality of bank accounts associated with a single UIDAI ID. Yet further, there is a need for a solution that address each of the drawbacks cited above.

### SUMMARY

The disclosure provides methods, systems and computer program products that enable optimized direct benefit transfers involving electronic remittance of benefit payments from a disbursing entity (for example, a government entity or department, an administrative department or any corporate or financial department) to electronic payment accounts of one or more beneficiaries.

In an embodiment, the disclosure provides a system for implementing optimized electronic routing of a direct benefit transfer payment from an originator payment account associated with an originator of the direct benefit transfer payment, to a beneficiary payment account associated with a beneficiary of the direct benefit transfer payment. The system comprises (i) a processor implemented trusted intermediary platform server configured to function as a communication intermediate between (i) an originator bank server configured to initiate a direct benefit transfer payment from an originator payment account controlled by the originator bank server, and (ii) a beneficiary bank server configured to receive electronic payments.

The trusted intermediary platform server is configured to (i) receive from the originator bank server a user identifier uniquely associated with the beneficiary, and transaction amount information defining a transaction amount, corresponding to the direct benefit transfer payment, (ii) determine based on a data record associated with the received user identifier, and that is retrieved from a database, a payment account identifier, wherein the payment account identifier identifies the payment account that is associated with the beneficiary at a beneficiary bank, and (iii) route to a beneficiary bank server, the payment account identifier and the transaction amount information.

The beneficiary bank server may be configured to respond to a transaction disbursement that includes crediting to the identified beneficiary bank a disbursement amount that includes the transaction amount, by crediting the payment account associated with the beneficiary, with the transaction amount.

In a particular embodiment of the system, the data record associated with the beneficiary that is retrieved from the database, is a data record generated by trusted intermediary platform server in response to receiving from a terminal device operated by the beneficiary (i) the user identifier uniquely associated with the beneficiary, wherein said user identifier has been generated by an identity verification platform and is associated in data records of the identity verification platform with identity information and biometric information corresponding to the beneficiary, and (ii) the payment account identifier.

The trusted intermediary platform server may be configured to generate the data record that is associated with the beneficiary and that is retrieved from the database, to include the user identifier, and the payment account identifier.

In a specific embodiment, the data record associated by the beneficiary that is retrieved from the database is generated by trusted intermediary platform server subsequent to positive verification of identity of the beneficiary by the identity verification platform.

The system may be configured such that determination of the beneficiary bank identifier and the payment account identifier, comprises (i) retrieving from the database, a plurality of data records associated with the received user identifier, (ii) selecting one data record from among the plurality of data records associated with the received user identifier, and (iii) extracting from the selected data record, at least the payment account identifier.

In an embodiment of the system, selection of the one data record from among the plurality of data records associated with the received user identifier is based on a received user input, or on determining a match between an originator identifier retrieved from the data record, and an originator identifier associated with the originator of the direct benefit transfer payment.

The disclosure also provides a method for implementing optimized electronic routing of a direct benefit transfer payment from an originator payment account associated with an originator of the direct benefit transfer payment to a beneficiary payment account associated with a beneficiary of the direct benefit transfer payment.

The method comprises implementing at a processor implemented trusted intermediary platform server configured to function as a communication intermediate between (i) an originator bank server configured to initiate a direct benefit transfer payment from an originator payment account controlled by the originator bank server, and (ii) a beneficiary bank server configured to receive electronic payments, the s of (a) receiving from the originator bank server a user identifier uniquely associated with the beneficiary, and transaction amount information defining a transaction amount, corresponding to the direct benefit transfer payment, (b) determining based on a data record associated with the received user identifier, and that is retrieved from a database, a payment account identifier, wherein the payment account identifier identifies the payment account that is associated with the beneficiary at a beneficiary bank, and (c) routing to a beneficiary bank server that is identified based on the beneficiary bank identifier, the payment account identifier and the transaction amount information.

The beneficiary bank server may be configured to respond to a transaction disbursement that includes crediting to the identified beneficiary bank a disbursement amount that includes the transaction amount, by crediting the payment account associated with the beneficiary, with the transaction amount.

In a method embodiment the data record associated with the beneficiary that is retrieved from the database is a data record generated by trusted intermediary platform server in response to receiving from a terminal device operated by the beneficiary, (i) the user identifier uniquely associated with the beneficiary, wherein said user identifier has been generated by an identity verification platform and is associated in data records of the identity verification platform with identity information and biometric information corresponding to the beneficiary, and (ii) the payment account identifier.

For implementing the method of the present disclosure, the trusted intermediary platform server may be configured to generate the data record that is associated with the beneficiary and that is retrieved from the database, to include the user identifier, and the payment account.

In a particular embodiment of the method, the data record associated by the beneficiary that is retrieved from the database is generated by trusted intermediary platform server subsequent to positive verification of identity of the beneficiary by the identity verification platform.

In a further embodiment of the method, determination of the payment account identifier, comprises (i) retrieving from the database, a plurality of data records associated with the received user identifier, (ii) selecting one data record from among the plurality of data records associated with the received user identifier, and (iii) extracting from the selected data record, at least the payment account identifier.

According to a particular embodiment of the method, selection of the one data record from among the plurality of data records associated with the received user identifier is based on a received user input, or determining a match between an originator identifier retrieved from the data record, and an originator identifier associated with the originator of the direct benefit transfer payment.

The disclosure yet further provides a computer program product for implementing optimized electronic routing of a direct benefit transfer payment from an originator payment account associated with an originator of the direct benefit transfer payment to a beneficiary payment account associated with a beneficiary of the direct benefit transfer payment. The computer program product comprises a non-transitory computer usable medium having computer readable program code embodied therein, the computer readable program code comprising instructions for implementing at a processor implemented trusted intermediary platform server configured to function as a communication intermediate between (i) an originator bank server configured to initiate a direct benefit transfer payment from an originator payment account controlled by the originator bank server, and (ii) a beneficiary bank server configured to receive electronic payments, the s of (a) receiving from the originator bank server a user identifier uniquely associated with the beneficiary, and transaction amount information defining a transaction amount, corresponding to the direct benefit transfer payment, (b) determining based on a data record associated with the received user identifier, and that is retrieved from a database, a payment account identifier, wherein the payment account identifier identifies the payment account that is associated with the beneficiary at a beneficiary bank, and (c) routing to a beneficiary bank server, the payment account identifier and the transaction amount information.

The beneficiary bank server is configured to respond to a transaction disbursement that includes crediting to the identified beneficiary bank a disbursement amount that includes the transaction amount, by crediting the payment account associated with the beneficiary, with the transaction amount.

### BRIEF DESCRIPTION OF THE DRAWINGS

FIG. 1 illustrates a prior art system environment set up by the NPCI through which electronic payments can be made from a payor bank to a payee bank.

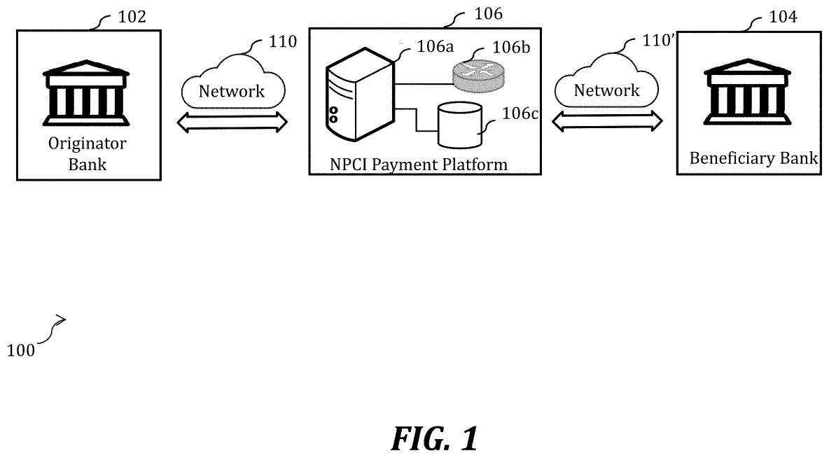

FIG. 2 illustrates a system configured to enroll a user for availing direct benefit transfers through the system environment of FIG. 1.

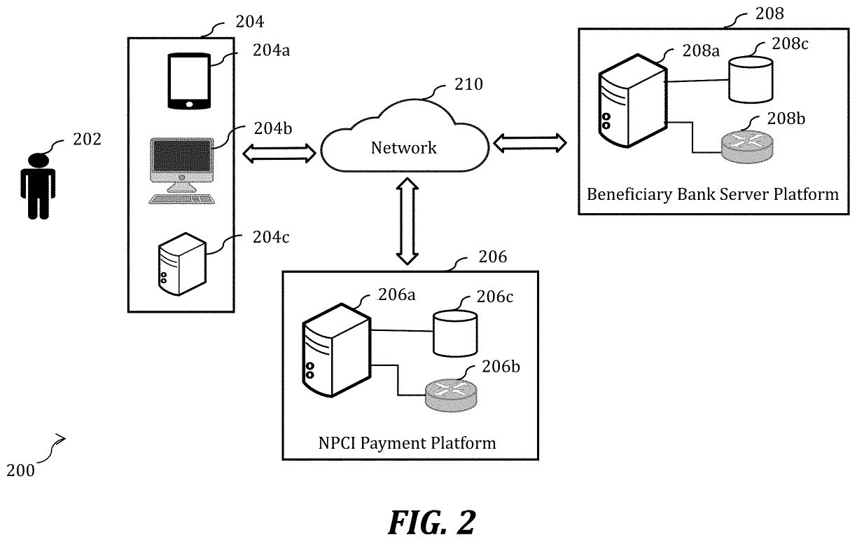

FIG. 3 is a flowchart illustrating a method for enrolling a user for availing direct benefit transfers through the system environment of FIG. 1.

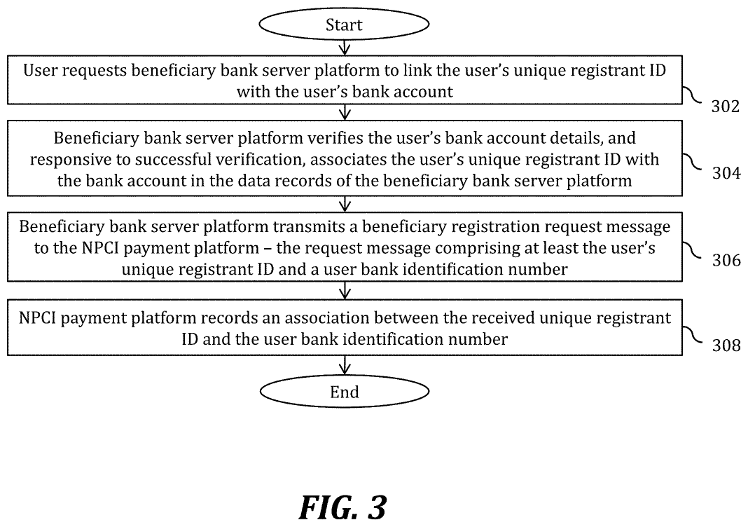

FIG. 4 illustrates a communication flow diagram illustrating the communication flow between entities when implementing the method of FIG. 3.

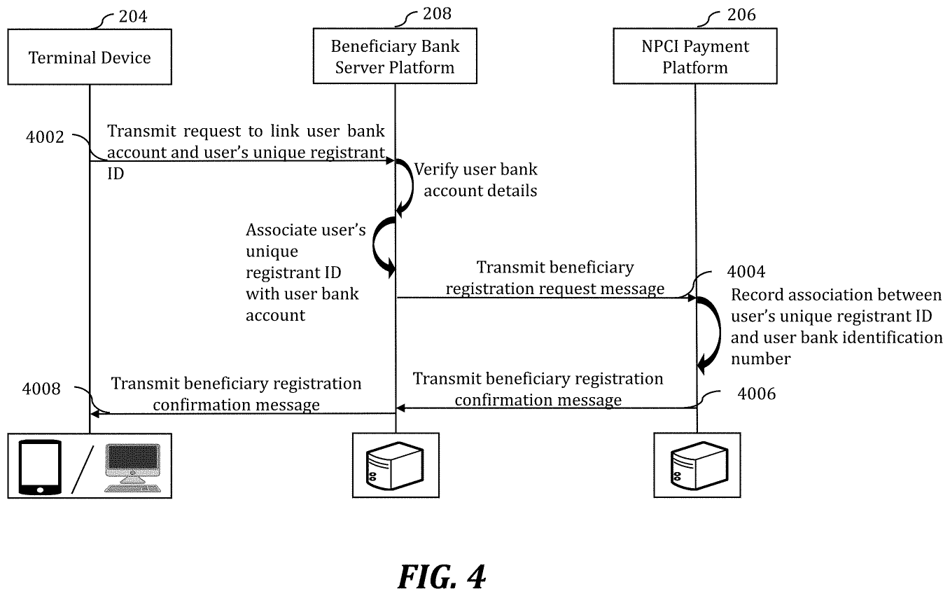

FIG. 5 illustrates a system environment comprising entities involved in implementing direct benefit transfer payments within the electronic payment infrastructure described in connection with FIGS. 1 to 4.

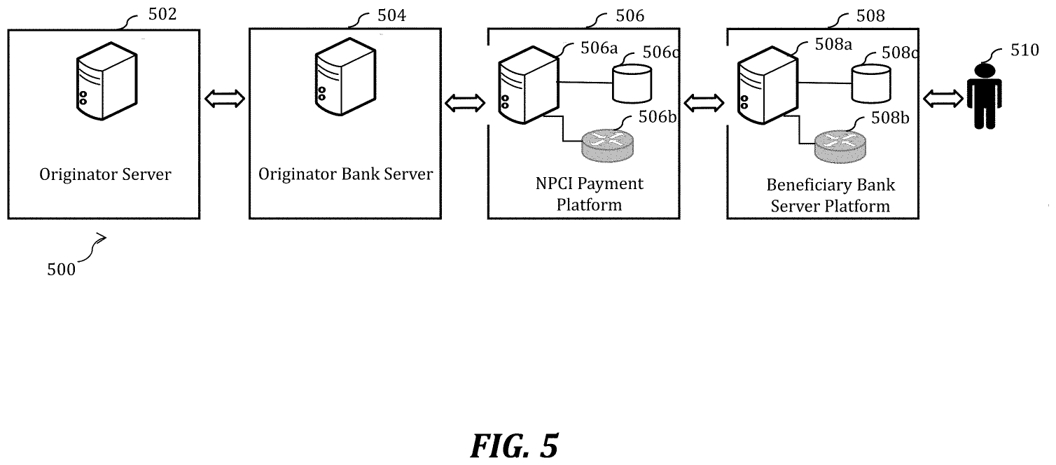

FIG. 6 illustrates a flowchart describing a method for implementing a direct benefit transfer payment within the system environment of FIG. 5.

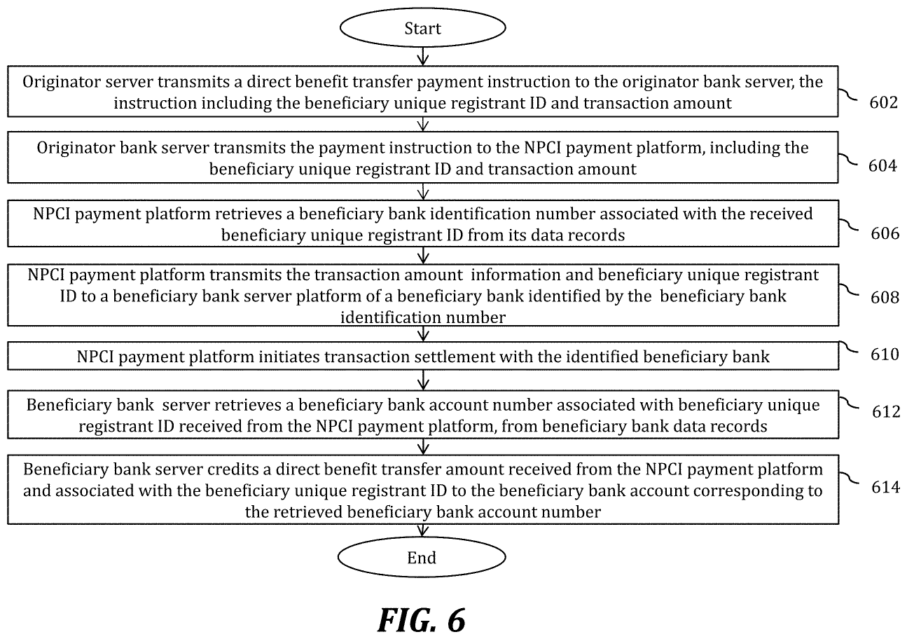

FIG. 7 illustrates an example of a data record structure of a type that is capable of being used for the purposes of the method of FIG. 3.

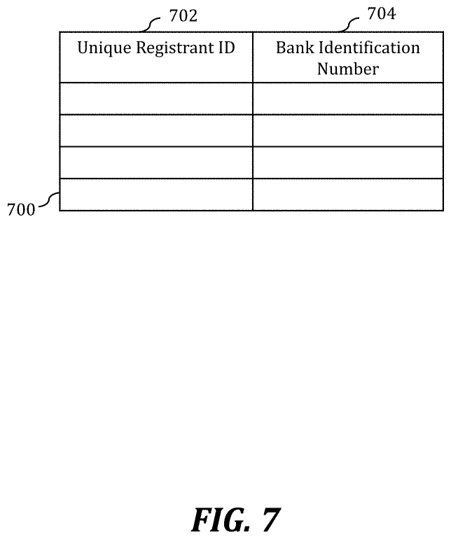

FIG. 8 illustrates a system environment configured in accordance with the teachings of the present disclosure for implementing optimized electronic routing of direct benefit transfers to beneficiaries.

FIG. 9 illustrates a system configured to enroll a user for availing direct benefit transfers through the system environment of FIG. 8.

FIG. 10 is a flowchart illustrating a method for enrolling a user for availing direct benefit transfers through the system environment of FIG. 8.

FIG. 11 illustrates an example of a data record structure of a type that is capable of being used for the purposes of the method of FIG. 10.

FIG. 12 illustrates a system environment comprising entities involved in implementing direct benefit transfer payments within the electronic payment infrastructure described in connection with FIGS. 8 to 11.

FIG. 13 illustrates a flowchart describing a method for implementing a direct benefit transfer payment within the system environment of FIG. 12.

FIG. 14 illustrates a communication flow diagram illustrating the communication flow between entities when implementing the method of FIG. 13.

FIG. 15 illustrates a particular embodiment of specific methods s within the method of FIG. 12.

FIG. 16 illustrates an intermediary platform server configured in accordance with the teachings of the present disclosure.

FIG. 17 illustrates an example of a computer system according to which various embodiments of the present disclosure may be implemented.

### DETAILED DESCRIPTION

The disclosure provides methods, systems and computer program products that optimize direct benefit transfers involving electronic remittance of benefit payments from a disbursing entity (for example, a government entity or department, an administrative department or any corporate or financial department) to electronic payment accounts of one or more beneficiaries.

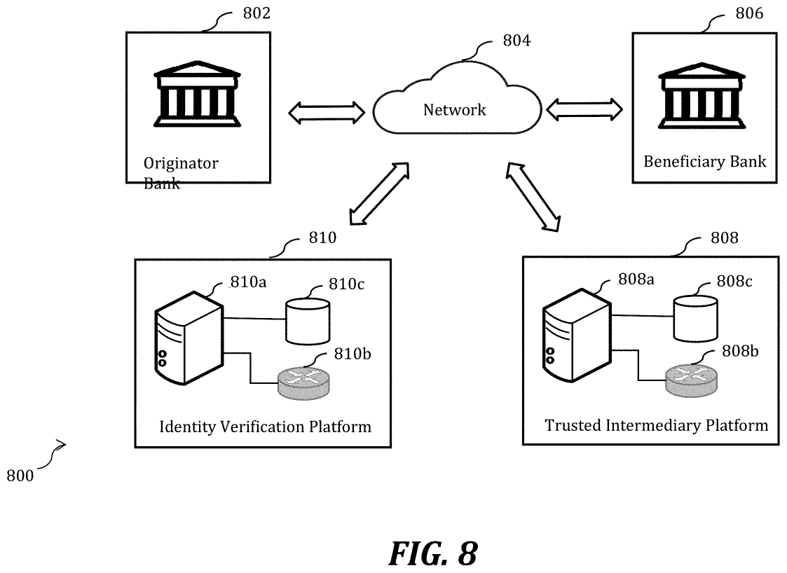

FIG. 8 illustrates a system environment 800 configured in accordance with the present disclosure, through which electronic payments can be made from a payor bank to a payee bank.

System environment 800 comprises an originator bank 802, beneficiary bank 806, trusted intermediary platform 808, and identity verification platform 810. Each of originator bank 802, beneficiary bank 806, trusted intermediary platform 808, and identity verification platform 810 are configured for network-based data communication with each other through network 804—which may comprise a data network or other communication network.

Originator bank 802 is a bank at which the government department or other entity responsible for initiating a direct benefit transfer payment, holds an electronic payment account. Beneficiary bank 806 is a bank at which an intended recipient of the direct benefit transfer payment holds an electronic payment account.

Trusted intermediary platform 808 comprises intermediary platform server 808a, intermediary platform gateway interface 808b, and intermediary platform database 808c. Intermediary platform server 808a may be configured to perform clearinghouse and/or settlement related functions to enable fund transfers between accounts maintained at originator bank 802 and accounts maintained at one or more beneficiary banks 806. Intermediary platform server 808a may comprise at least one processor, and one or more transitory and/or non-transitory memories. Intermediary platform gateway interface 808b may include a hardware or software network gateway configured to enable transmission and receipt of communications by intermediary platform server 808a. In particular embodiments of the disclosure, intermediary platform gateway interface 808b enables intermediary platform server 808a to communicate with beneficiary bank 806 and/or identity verification platform 810 for effecting one or more of the methods described below. Intermediary platform database 808c may include a non-transitory memory based database configured to enable storage and retrieval of trusted intermediary platform data records.

Identity verification platform 810 comprises identity verification platform server 810a, identity verification platform gateway interface 810b, and identity verification platform database 810c. Identity verification platform server 810a may be configured to perform one or more of the functions that are discussed in more detail below. Identity verification platform server 810a may comprise at least one processor, and one or more transitory and/or non-transitory memories. Identity verification platform gateway interface 810b may include a hardware or software network gateway configured to enable transmission and receipt of communications by identity verification platform server 810a. Identity verification platform database 810c may include a non-transitory memory based database configured to enable storage and retrieval of identity verification platform data records.

Identity verification platform server 810a is configured to store identity information regarding registrants, said identity information including at least a unique registrant ID that is uniquely associated with the corresponding registrant, along with additional identity data/metadata corresponding to said registrant. The additional identity data/metadata corresponding to a registrant includes at the very least, registrant biometric data (i.e. one or more biometric templates generated based on biometric features of such registrant). In an embodiment of the disclosure, identity verification platform 810 is a UIDAI identity verification platform set up by the Government of India, and in the embodiment, the registrant IDs maintained by identity verification platform 810 consist of the unique IDs/Aadhar numbers issued to individuals under the Aadhar project. However, it would also be understood that any other government or private sector backed unique identification platform that issues unique identifiers to enrolled individuals—and which unique identifiers can be linked to the corresponding enrolled individual's payment account(s), would work equally well for the purposes of the system environment under discussion. Examples of other such unique identifiers may include driving license IDs, social security number(s), identification number(s) issued by the national taxation/revenue services (for example, a Permanent Account Number (PAN) issued by the Indian Income Tax Department), or an originator-specific (or originator issued) beneficiary identifier etc.

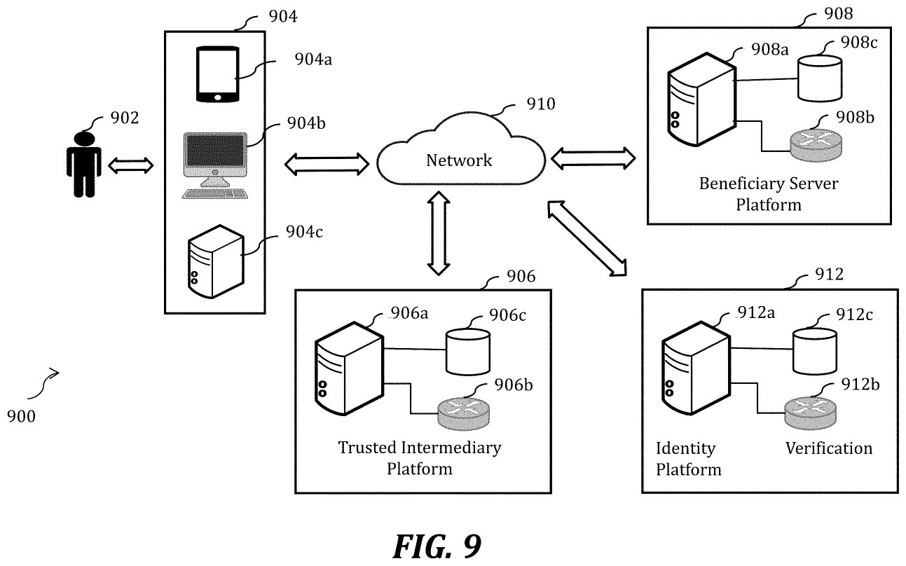

The manner in which system environment 800 of FIG. 8 is configured to optimize direct benefit payment transactions between an originator bank account and a beneficiary bank account, may be understood in accordance with the further implementation details provided below in connection with FIGS. 9 to 16.

FIG. 9 illustrates a system 900 configured to enroll a user 902 for availing direct benefit transfers through the system environment 800 of FIG. 8. System 900 comprises user 902, terminal device 904, trusted intermediary platform 906, beneficiary bank server platform 908, network 910, and identity verification platform 912 (which may in an embodiment comprise the UIDAI identity verification platform implemented by the Government of India).

Each of terminal device 904, trusted intermediary platform 906, beneficiary bank server platform 908 and identity verification platform 912 are communicably coupled with each other through network 910.

Terminal device 904 may comprise any processor implemented network communication enabled device, through which a user 902 can initiate and control a process for enrollment for direct benefit bank transfer services with trusted intermediary platform 906. In the illustrated embodiment, terminal device 904 may comprise any of mobile communication device 904a, computer terminal 904b or server device 204c.

Trusted intermediary platform 906 comprises intermediary platform server 906a and intermediary platform gateway interface 906b, respectively configured to implement functionality described in connection with FIG. 8. Trusted intermediary platform 906 additionally includes intermediary platform database 906c, which is configured to store data records in accordance with the methods described in more detail below.

Beneficiary bank server platform 908 comprises beneficiary bank server 908a, beneficiary bank gateway interface 908b and beneficiary bank database 908c. Beneficiary bank server 908a may comprise at least one processor, and one or more transitory and/or non-transitory memories—and may be configured to generate, monitor and maintain electronic payment accounts, and to control transfer of funds into and out of such electronic payment accounts. Beneficiary bank gateway interface 908b may include a hardware or software network gateway configured to enable transmission and receipt of communications by beneficiary bank server 908a. Beneficiary bank database 908c may comprise a non-transitory memory based database, configured to store data records corresponding to electronic payment accounts maintained at the beneficiary bank, and corresponding to payment transactions involving such electronic payment accounts.

Identity verification platform 912 comprises identity verification platform server 912a, identity verification platform gateway interface 912b, and identity verification platform database 912c, respectively configured to implement functionality described in connection with FIG. 8.

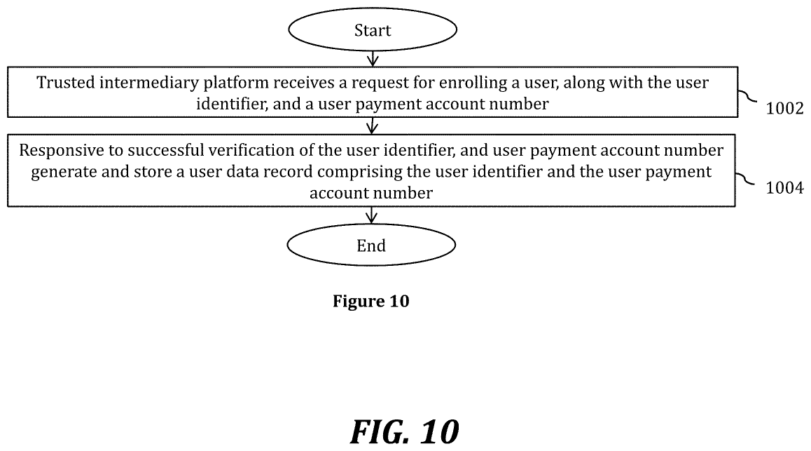

The method by which a user 902 is enrolled for availing direct benefit transfers through system 900 is described in connection with the flowchart of FIG. 10. The method of FIG. 10 assumes that user 902 is already enrolled with identity verification platform 912, and has been allocated a unique user identifier (or user identification number)—which user identifier (or user identification number) can be used by identity verification platform 912 to retrieve identity records of corresponding to user 902, that are stored therewithin. The method of FIG. 9 also assumes that user 902 holds a payment account with the beneficiary bank—and that the user payment account is maintained by beneficiary bank server platform 908.

At 1002, trusted intermediary platform 906 (or intermediary platform server 906a within trusted intermediary platform 906) receives a request for enrolling a user 902, along with a user identifier (or user identification number) corresponding to said user 902 (that has been generated or associated with said user by identity verification platform 912), a user payment account number corresponding to a payment account held by user 902 at beneficiary bank server 908a. The request at 1002 may be received from terminal device 904—at which terminal device 904, such request may have been generated based on an instruction or input from user 902. The request may alternately be received through any other one or more gateway devices or terminal devices that are configured to enable generation of such requests. In a particular embodiment of the method of FIG. 10, the request for enrollment at 1002 may additionally be accompanied by an originator identifier (for example, an originating bank payment account identifier). The object of providing the originator identifier with the request for enrollment at 1002 is to enable trusted intermediary platform 906 to record an association with the user identifier and the user payment account number that are also received along with the request for enrollment and to store this association in its data records. As a result of recording this association, when trusted intermediary platform 906 receives a payment instruction for a direct benefit transfer payment to a user identified by a particular user identifier, and the direct benefit transfer payment originates from a payment account corresponding to an originator identifier that has been linked with the particular user identifier—the trusted intermediary platform 906 identifies the user payment account number that is associated with both of the originator identifier and the user identifier, and routes the direct benefit transfer payment into the payment account identified by such user payment account number. It would be understood that recording this additional association between an originator identifier and the user identifier and the user payment account number, enables trusted intermediary platform 906 to respond to receiving a direct benefit transfer payment from an originator payment account corresponding to the originator identifier, by dynamically routing the direct benefit transfer payment to a specific user payment account that is identified by the user payment account number associated with the originator identifier.

Intermediary platform server 906a may verify one or more of the received user identifiers (or user identification number) and a user payment account number. The verification process may comprise any one or more processes that are well known in the art. In the case of a received user payment account number, verification may comprise ascertaining the integrity and correctness of the received number(s), and optionally, ascertaining that the user payment account number does in fact belong to the requesting user 902—through one or more challenge-response type inquiries or through OTP based verification. In the case of the user identifier (or user identification number) (for example a UIDAI ID number), verification may include one-time-password based verification or biometric feature based verification of user 902—and may involve requesting and receiving from identity verification platform 912, verification of identity of user 902.

At 1004, responsive to successful verification of the identity of user 902, user identifier (or user identification number) and/or payment account number, intermediary platform server 906a generates and stores a user data record comprising the received user identifier (or user identification number), the payment account number, and optionally an originator identifier that is intended to be linked to the user identifier and the payment account number, in the data records of trusted intermediary platform 906. Generation of said data record has the effect of storing at trusted intermediary platform 906, associations between the received user identifier (or user identification number), the payment account number and optionally an originator identifier that is intended to be linked to the user identifier and the payment account number.

While not shown in the flowchart of FIG. 10, the method may thereafter involve transmitting to terminal device 904 or other device, a data message confirming successful enrollment of user 902 for availing direct benefit transfers through system 900.

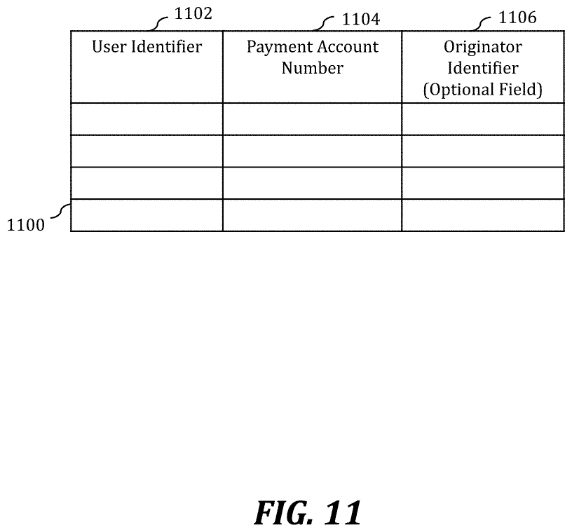

FIG. 11 illustrates an example of a data record structure 1100 of a type that is capable of being used for storing the user identifier (or user identification number), payment account number, and optionally an originator identifier that is intended to be linked to the user identifier and the payment account number in 1004 of FIG. 10. As shown in FIG. 11, data record structure 1100 comprises a first data field 1102 for storing a user identifier (or user identification number) (for example, a UIDAI ID number or any other identifier that is uniquely associated with a user or beneficiary), a second data field 1104 for storing the payment account number, and a third optional data field 1106 for storing an originator identifier that is intended to be linked to the user identifier and the payment account number.

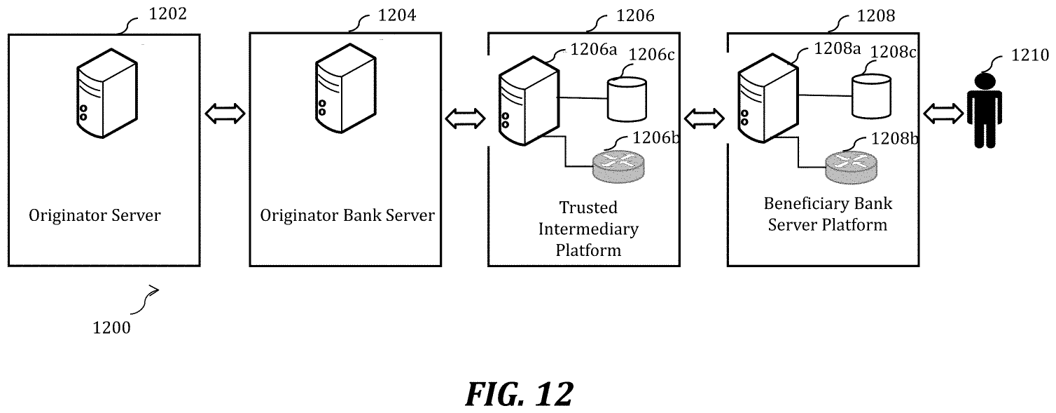

FIG. 12 illustrates a system environment 1200 comprising the various entities involved in implementing direct benefit transfer payments within the optimized electronic payment infrastructure that has been described above in connection with FIGS. 8 to 11.

System environment 1200 comprises originator server 1202, originator bank server 1204, trusted intermediary platform 1206, beneficiary bank server platform 1208 and beneficiary 1210. Originator server 1202 is a server associated with and operated and controlled by the government department or other entity responsible for initiating a direct benefit transfer payment. Originator bank server 1204 is a server operated or controlled by an originator bank at which the government department or other entity responsible for initiating a direct benefit transfer payment, holds an electronic payment account. Trusted intermediary platform 1206 is the settlement platform that has been discussed in detail in connection with FIGS. 8 to 11 above—and comprises intermediary platform server 1206a, intermediary platform gateway interface 1206b and intermediary platform database 1206c. Likewise, beneficiary bank server platform 1208 may be configured in accordance with embodiments discussed in detail in connection with FIGS. 8 to 11 above—and comprises beneficiary bank server 1208a, beneficiary platform gateway interface 1208b and beneficiary bank server database 1208c. Beneficiary 1210 is the intended beneficiary of the direct benefit transfer payment, and holds a payment account maintained by or within beneficiary bank server platform 1208.

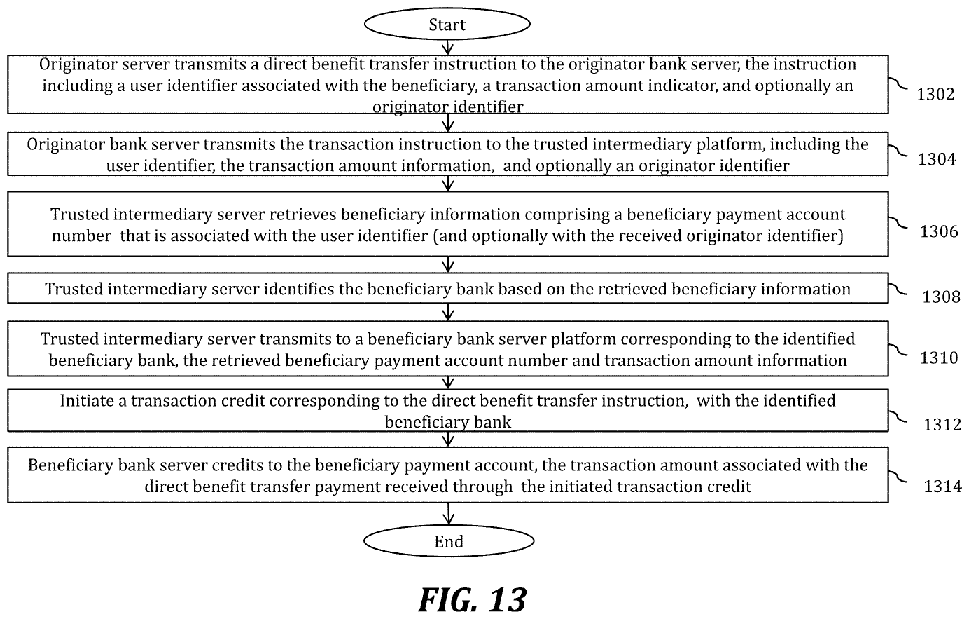

FIG. 13 illustrates a flowchart describing a method for implementing a direct benefit transfer payment within system environment 1200. For the purposes of describing the method of FIG. 13, it would be understood that for implementing a direct beneficiary transfer payment initiated at an originator server 1202 and directed to reach beneficiary 1210, trusted intermediary platform 1206 has been previously updated by recording an association between a user identifier (or user identification number) (in an embodiment, a UIDAI ID or any other identifier that is uniquely associated with a user or beneficiary) corresponding to beneficiary 1210, a payment account number corresponding to a payment account held by beneficiary 1210 at beneficiary bank server platform 1208, and optionally, an originator identifier that is intended to be linked to the user identifier and the payment account number. In an embodiment, said association may be recorded within intermediary platform database 1206c within trusted intermediary platform 1206, through a data record generated in accordance with the method of FIG. 10, and that is based on a data record structure illustrated and described above in connection with FIG. 11.

1302 comprises transmitting from originator server 1202 to originator bank server 1204, a direct benefit transfer payment instruction. The transaction payment instruction comprises or is accompanied by a user identifier (or user identification number) (in an embodiment, a UIDAI ID or any other identifier that is uniquely associated with a user or beneficiary) associated with the intended beneficiary 1210, and also by an indicator of the transaction amount. In an optional embodiment, the transaction payment instruction may also be accompanied by an originator identifier that identifies the originator of the direct benefit transfer payment instruction.

At 1304, originator bank server 1204 transmits the transaction payment instruction to trusted intermediary platform 1206. The transaction payment instruction transmitted from originator bank server 1204 comprises or is accompanied by the user identifier (or user identification number) associated with the intended beneficiary 1210, and the indicator of the transaction amount. In an optional embodiment, the transaction payment instruction may also be accompanied by an originator identifier that identifies the originator of the direct benefit transfer payment instruction.

At 1306, responsive to receiving the transaction instruction (accompanied by the user identifier (or user identification number), the indicator of the transaction amount, and optionally, an originator identifier that is intended to be linked to the user identifier and the payment account number, intermediary platform server 1206a within trusted intermediary platform 1206, retrieves from its data records (for example, data records stored within intermediary platform database 1206c), beneficiary information associated with the information received with the transaction information. In an embodiment where the transaction information is accompanied by the user identifier, trusted intermediary platform 1206 retrieves from its records, a payment account number that is associated with the received user identifier (or user identification number) corresponding to the intended beneficiary. In an embodiment where the transaction instruction is accompanied by the user identifier as well as an originator identifier, and where the data records of trusted intermediary platform 1206 that are associated with the user identifier also include an association between the user identifier and an originator identifier, trusted intermediary platform retrieves both payment account number(s) and originator identifier(s) associated with the received user identifier (or user identification number).

At 1308, intermediary platform server 1206a identifies a beneficiary bank at which a payment account associated with beneficiary 1210 is held or maintained, wherein said identification is based on the beneficiary information retrieved at 1306. In an embodiment, the beneficiary bank is identified based on a part or the whole of the retrieved beneficiary payment account number. In another embodiment where the transaction instruction is accompanied by the user identifier as well as an originator identifier, and where trusted intermediary platform has retrieved from its data records, a plurality of different payment account number(s) and associated originator identifier(s) associated with the received user identifier (or user identification number), intermediary platform server 1206a selects a payment account and a beneficiary bank at which said payment account is held, based on identification of a payment account number that is associated with the received user identifier and with the received originator identifier.

At 1310, intermediary platform server 1206a transmits to a beneficiary bank server platform 1208 corresponding to the identified beneficiary bank, the retrieved beneficiary payment account number and transaction amount information. The transmitted beneficiary payment account number and transaction amount information may be received at beneficiary bank server 1208a.

1312 comprises initiating a transaction settlement with the identified beneficiary bank—which transaction settlement may be either limited to the direct benefit transfer amount sought to be transferred to beneficiary 1210, or may comprise a batch transaction settlement that includes the direct benefit transaction amount sought to be transferred to beneficiary 1210 as part of a larger settlement amount.

At 1314, beneficiary bank server 1208a credits to a beneficiary payment account identified by the beneficiary payment account number received at 1310, the transaction amount associated with the direct benefit transfer credit that has been initiated at 1312.

It would be understood that by implementing the method of FIG. 13, the present disclosure enables trusted intermediary platform 1206 and/or intermediary platform server 1206a to generate and transmit to one or both of the crediting entity and a receiving entity that are respectively responsible for crediting and receiving the direct benefit transfer payment (e.g. a payment platform/settlement platform/clearing platform on the crediting side and the beneficiary bank on the receiving side), a complete set of data that is necessary for the crediting entity and/or the receiving entity to enable a direct benefit transfer payment.

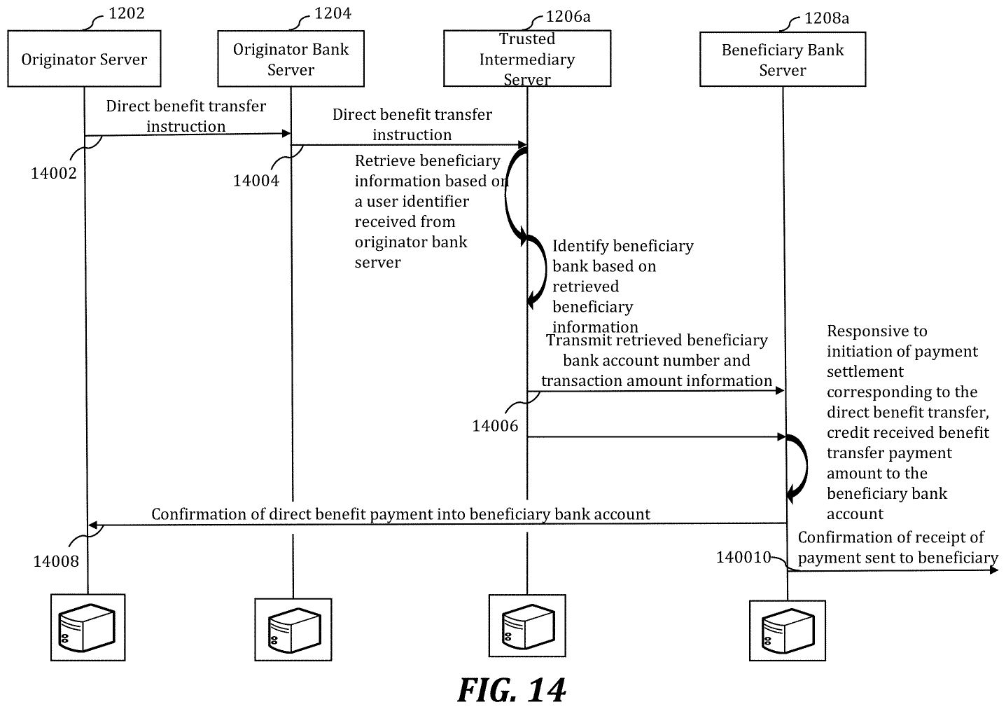

FIG. 14 illustrates a communication flow diagram illustrating the communication flow between entities when implementing the method of FIG. 13.

14002 comprises transmitting from originator server 1202 to originator bank server 1204, the direct benefit transfer payment instruction. The transfer payment instruction comprises or is accompanied by a user identifier (or user identification number) associated with an intended beneficiary 1210, and an indicator of the transaction amount, and optionally an originator identifier.

At 14004, originator bank server 1204 transmits the transfer payment instruction to intermediary platform server 1206a. The transfer payment instruction transmitted from originator bank server 1204 comprises or is accompanied by the user identifier (or user identification number) associated with the intended beneficiary 1210, and the indicator of the transaction amount, and optionally an originator identifier.

Responsive to receiving the transaction instruction (accompanied by the user identifier (or user identification number) and the indicator of the transaction amount), intermediary platform server 1206a retrieves from its data records (for example, data records stored within an intermediary platform database 1206c), beneficiary information associated with the received user identifier (or user identification number), wherein the retrieved beneficiary information comprises a beneficiary payment account number, and optionally, an originator identifier.

Intermediary platform server 1206a thereafter identifies a beneficiary bank at which a payment account associated with beneficiary 1210 is held or maintained, wherein said identification is based on the retrieved beneficiary information. In an embodiment, the beneficiary bank is identified based on a part or the whole of the retrieved beneficiary payment account number. In another embodiment where the transaction instruction is accompanied by the user identifier as well as an originator identifier, and where trusted intermediary server 1206a has retrieved from its data records, a plurality of different payment account number(s) and associated originator identifier(s) associated with the received user identifier (or user identification number), trusted intermediary server 1206a selects a payment account and a beneficiary bank at which said payment account is held, based on identification of a payment account number that is associated with the received user identifier and with the received originator identifier.

At 14006, intermediary platform server 1206a transmits to a beneficiary bank server 1208a that corresponds to the identified beneficiary bank, the retrieved beneficiary payment account number and transaction amount information.

Responsive to initiation of payment settlement corresponding to the direct benefit transfer under implementation, beneficiary bank server 1208a credits to a beneficiary payment account identified by the beneficiary payment account number received at 14006, the transaction amount associated with the direct benefit transfer.

Thereafter 14008 comprises transmission of a data message from beneficiary bank server 1208a to originator server 1202, confirming that the direct benefit transaction payment has been transferred into a beneficiary bank account associated with intended beneficiary 1210. While 14008 illustrates the transmission of the data message being implemented directly between beneficiary bank server 1208a and originator server 1202, it would be understood that this data message may be transmitted directly between the two system entities, or alternatively through multiple data messages passed through a series of communication intermediaries (for example, through a first data message from beneficiary bank server 1208a to trusted intermediary server 1206a, a second data message from trusted intermediary server 1206a to originator bank server 1204 and a third data message from originator bank server 1204 to originator server 1202). 14010 further comprises transmitting from beneficiary bank server 1208a to a terminal device associated or accessible by beneficiary 1210, confirmation of receipt of the direct benefit transaction payment into the beneficiary bank account.

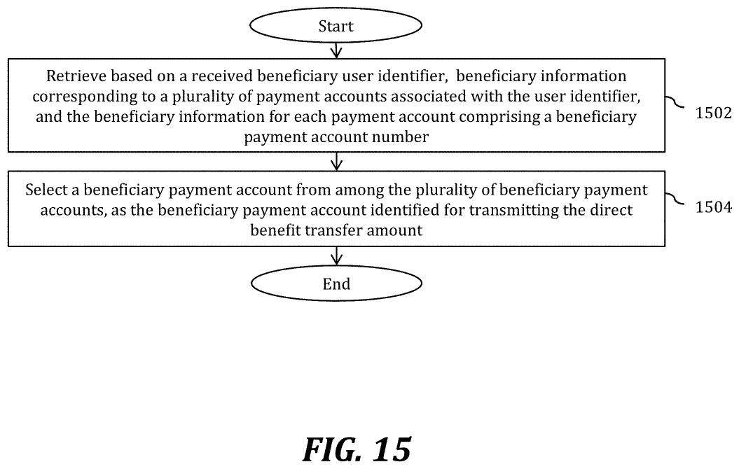

FIG. 15 illustrates a particular embodiment of method s 1306 and 1308 of FIG. 13—wherein a user identifier (or user identification number) corresponding to intended beneficiary 1210 may be associated with a plurality of different payment accounts (i.e. a plurality of payment account numbers and, within the data records of trusted intermediary platform 1206. It would be understood that a plurality of different payment accounts may be associated with a single user identifier (or user identification number), if the beneficiary associated with such user identifier (or user identification number) has completed the enrollment process for each such payment account in accordance with the method of FIG. 10 (for example, through multiple iterations of the method of FIG. 10). In such an event, the method of FIG. 15 may be implemented for selecting a specific payment account to which the direct benefit transfer payment that is under process, requires to be credited.

It would be understood that s 1502 and 1504 of FIG. 15 may be implemented subsequent to 1304 and prior to 1310 of the method of FIG. 13 (i.e. as a substitute to the method s 1306 and 1308). In a particular embodiment, the 1502 and 1504 of FIG. 15 may be implemented for direct benefit transfer payments that are directed to a user identifier that has multiple payment accounts linked to it in the data records of the trusted intermediary platform (906, 1206), and in an even more particular embodiment, where one or more of said multiple payment accounts linked to the user identifier also have a corresponding originator identifier linked thereto.

At 1502, responsive to receiving the transaction instruction (accompanied by the user identifier (or user identification number) and the indication of the transaction amount) from originator bank server 1204, intermediary platform server 1206a retrieves from its data records (for example, data records stored within intermediary platform database 1206c), beneficiary information associated with the received user identifier (or user identification number), wherein the retrieved beneficiary information comprises (i) a plurality of beneficiary payment account numbers associated with the user identifier (or user identification number), and optionally (ii) an originator identifier associated with one or more of the retrieved beneficiary payment account numbers.

At 1504, intermediary platform server 1206a selects a particular beneficiary payment account number from among the plurality of beneficiary payment account numbers retrieved at 1502, as the destination payment account for crediting the direct benefit transaction payment amount.

It would be understood that selection of a particular beneficiary payment account number from among the plurality of retrieved beneficiary payment account numbers, may be implemented in any number of different ways. In one, the selection may be based on user input requested and retrieved from beneficiary 1210. In another, the selection may be rule-based, which relies on one or more predefined rules for routing direct benefit transfer payments among multiple payment accounts held by beneficiary 1210—for example, based on any of, type of payment, payment amount, payment date or time, source of the direct benefit payment transfer, and/or available credit balance in one or more of the plurality of payment accounts associated with beneficiary 1210. In a particular embodiment, the selected beneficiary payment account number is a beneficiary payment account number that is linked with an originator identifier which matches an originator identifier corresponding to the originator (or originator bank or originator bank server) of the direct benefit transfer payment.

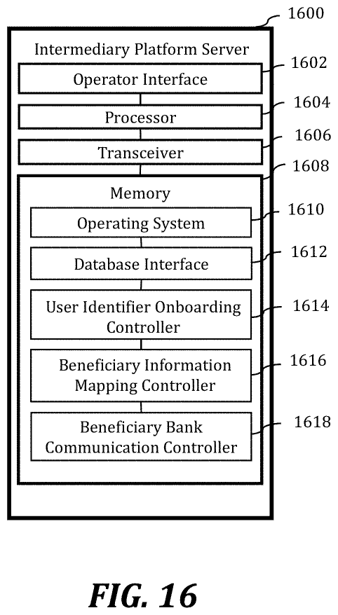

FIG. 16 illustrates an intermediary platform server 1600 configured in accordance with the teachings of the present disclosure. In an embodiment of the disclosure, intermediary platform server may be implemented within trusted intermediary platform (906, 1206) as described above.

Intermediary platform server 1600 may comprise any processor based server system configured for data processing operations and network based communication. In specific embodiments, intermediary platform server 1600 may comprise one or more servers. Intermediary platform server 1600 may include (i) an operator interface 1602 configured to enable an operator to configure or control intermediary platform server 1600, (ii) processor 1604 configured for data processing operations within intermediary platform server 1600, (iii) transceiver 1606 configured for enabling network communication to and from intermediary platform server 1600, and (iv) memory 1608, which memory 1608 may include transitory memory and/or non-transitory memory.

In an example of an embodiment, memory 1608 may have stored therewithin, (i) an operating system 1610 configured for managing device hardware and software resources and that provides common services for software programs implemented within intermediary platform server 1600, (ii) a processor implemented database interface 1612 configured to enable intermediary platform server 1600 to retrieve data records from and store data records in one or more databases associated or communicably coupled with intermediary platform server 1600, (iii) a user identifier onboarding controller 1614 configured to enable one or more user identifiers (for example, one or more UIDAI IDs) associated with a beneficiary to be enrolled within the data records of intermediary platform server 1600 (for example by implementing the method of FIG. 10), (iv) a processor implemented beneficiary information mapping controller 1616 configured to retrieve one or more data records associated with a user identifier received at intermediary platform server 1600, and to identify based on information extracted from the retrieved data records, beneficiary information associated with said user identifier (for example, payment account number and/or originator identifier(s) associated with said payment account number), and (v) a processor implemented beneficiary bank communication controller 1618 configured to enable intermediary platform server 1600 to communicate with and forward beneficiary information and transaction amount information to a beneficiary bank server associated with a beneficiary bank account to which a direct benefit transfer payment is being credited.

It will be understood that the intermediary platform server 1600 may be configured to implement one or more of the methods s and process flows discussed above in connection with FIGS. 8 to 15.

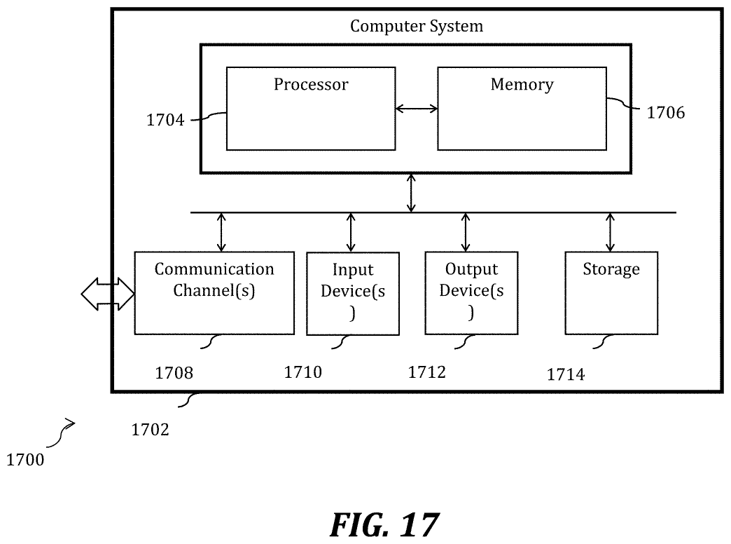

FIG. 17 illustrates an example of a computer system 1702 for implementing the present disclosure.

The illustrated system comprises computer system 1702 which in turn comprises one or more processors 1704 and at least one memory 1706. Processor 1704 is configured to execute program instructions—and may be a real processor or a virtual processor. It will be understood that computer system 1702 does not suggest any limitation as to scope of use or functionality of described embodiments. The computer system 1702 may include, but is not be limited to, one or more of a general-purpose computer, a programmed microprocessor, a micro-controller, an integrated circuit, and other devices or arrangements of devices that are capable of implementing the s that constitute the method of the present disclosure. Examples of embodiments of a computer system 1702 in accordance with the present disclosure may include one or more servers, desktops, laptops, tablets, smart phones, mobile phones, mobile communication devices, tablets, phablets and personal digital assistants. In an embodiment of the present disclosure, the memory 1706 may store software for implementing various embodiments of the present disclosure. The computer system 1702 may have additional components. For example, the computer system 1702 may include one or more communication channels 1708, one or more input devices 1710, one or more output devices 1712, and storage 1714. An interconnection mechanism (not shown) such as a bus, controller, or network, interconnects the components of the computer system 1702. In various embodiments of the present disclosure, operating system software (not shown) provides an operating environment for various software executing in the computer system 1702 using a processor 1704, and manages different functionalities of the components of the computer system 1702.

The communication channel(s) 1708 allow communication over a communication medium to various other computing entities. The communication medium provides information such as program instructions, or other data in a communication media. The communication media includes, but is not limited to, wired or wireless methodologies implemented with an electrical, optical, RF, infrared, acoustic, microwave, Bluetooth or other transmission media.

The input device(s) 1710 may include, but is not limited to, a touch screen, a keyboard, mouse, pen, joystick, trackball, a voice device, a scanning device, or any another device that is capable of providing input to the computer system 1702. In an embodiment of the present disclosure, the input device(s) 1710 may be a sound card or similar device that accepts audio input in analog or digital form. The output device(s) 1712 may include, but not be limited to, a user interface on CRT, LCD, LED display, or any other display associated with any of servers, desktops, laptops, tablets, smart phones, mobile phones, mobile communication devices, tablets, phablets and personal digital assistants, printer, speaker, CD/DVD writer, or any other device that provides output from the computer system 1702.

The storage 1714 may include, but not be limited to, magnetic disks, magnetic tapes, CD-ROMs, CD-RWs, DVDs, any types of computer memory, magnetic stripes, smart cards, printed barcodes or any other transitory or non-transitory medium which can be used to store information and can be accessed by the computer system 1702. In various embodiments of the present disclosure, the storage 1714 may contain program instructions for implementing any of the described embodiments.

In an embodiment of the present disclosure, the computer system 1702 is part of a distributed network or a part of a set of available cloud resources.

The present disclosure may be implemented in numerous ways including as a system, a method, or a computer program product such as a computer readable storage medium or a computer network wherein programming instructions are communicated from a remote location.

The present disclosure may suitably be embodied as a computer program product for use with the computer system 1702. The method described herein is typically implemented as a computer program product, comprising a set of program instructions that is executed by the computer system 1702 or any other similar device. The set of program instructions may be a series of computer readable codes stored on a tangible medium, such as a computer readable storage medium (storage 1714), for example, diskette, CD-ROM, ROM, flash drives or hard disk, or transmittable to the computer system 1702, via a modem or other interface device, over either a tangible medium, including but not limited to optical or analogue communications channel(s) 1708. The implementation of the disclosure as a computer program product may be in an intangible form using wireless techniques, including but not limited to microwave, infrared, Bluetooth or other transmission techniques. These instructions can be preloaded into a system or recorded on a storage medium such as a CD-ROM, or made available for downloading over a network such as the Internet or a mobile telephone network. The series of computer readable instructions may embody all or part of the functionality previously described herein.

Based on the above description, it would be apparent that the disclosure provides multiple significant technical improvements over the prior art, including:
optimizing network communication efficiency—inasmuch that seeding the system to enable a beneficiary to receive direct benefit transfer payments according to the present disclosure only requires data records associating the UIDAI ID or other unique beneficiary identifier to be maintained at a single platform (i.e. the trusted intermediary platform)—instead of at both of the beneficiary bank platform and the NPCI server platform. This eliminates problems of network latency, data messaging round-trip overheads, and differing load handling capabilities involving both of beneficiary bank server(s) and the settlement platform server(s), resulting in faster network response times, and lower network communication overheads. Additionally, network server failure at the beneficiary bank platform no longer causes an interruption to the process of seeding or enrolling new beneficiaries into the system, as the process of seeding/enrolling is carried out entirely at the trusted settlement platform,
reducing the number of data record retrievals required in a transaction—since in the present disclosure only a single state look-up is required at the trusted intermediary platform, to identify a payment account number and beneficiary bank information corresponding to a received UIDAI ID. This is in contrast with the prior art solutions where data record retrieval and the look-up process required to be carried out both at the NPCI server and at the beneficiary bank server, before a target payment account could be identified,
reducing overall data overheads and communication overheads—since it is now no longer necessary to ensure data integrity between a beneficiary bank server platform and an NPCI settlement platform,
eliminating transaction failure instances where data integrity between a beneficiary bank server platform and an NPCI payment platform has not been maintained,
enabling dynamic or instance specific routing of payment transactions among a plurality of payment accounts associated with a single beneficiary for transferring a specific instance of a direct benefit transfer payment,
enabling direct linking of a beneficiary identifier to a payment destination, e.g., bank account, card account, virtual ID etc.,
enabling support for multiple types of beneficiary identifier to be linked to a beneficiary payment destination,
enabling a beneficiary to link specific different destination payment accounts to specific originators—such that payments from a particular originator are automatically routed to the destination payment account linked to that originator,
enabling registration of beneficiaries at the trusted intermediary platform through any device or system or channel that is communicably coupled with the trusted intermediary platform (e.g. through an originator server, through the trusted intermediary server, and/or through a destination bank server)—instead of necessitating registration exclusively through the destination bank, since the registration no longer requires registration of the beneficiary's unique registrant ID at the destination bank,
eliminating the requirement to perform a second stage mapping at the destination bank to identify a bank account number/identifier associated with the unique registrant ID—thereby reducing the network overhead and the processing overheads for the destination bank.
enabling verification of the unique registrant ID and the payment destination by the identity verification platform prior to registering an individual as a new beneficiary within the trusted intermediary platform—thereby decreasing the risk of payment transaction errors and/or identity fraud,
enabling implementation of a payment agnostic platform which supports both batch and real time payments
eliminating the cost and effort involved in maintaining data integrity between the records of the destination bank and the trusted intermediary platform for the purposes of beneficiary registration, and instead ensuring data integrity through a “single source of truth” i.e. the trusted intermediary platform,
supporting identification of beneficiaries who are ineligible for direct benefit transfers through periodic review of data records,
eliminating reliance on file based National Automated Clearinghouse (NACH) solutions for settlement and clearance—and thereby eliminating the delay of multiple days required for payment clearance, and
reducing reconciliation effort and overheads for banks during the beneficiary registration and implementation of direct benefit transfer payment processes—with corresponding reductions to capital and operation expenses for banks.

While the examples of embodiments of the present disclosure are described and illustrated herein, it will be appreciated that they are merely illustrative. It will be understood by those skilled in the art that various modifications in form and detail may be made therein without departing from or offending the spirit and scope of the disclosure as defined by the appended claims. Additionally, the disclosure illustratively disclose herein suitably may be practiced in the absence of any element which is not specifically disclosed herein—and in a particular embodiment that is specifically contemplated, the disclosure is intended to be practiced in the absence of any one or more element which are not specifically disclosed herein.

What is claimed is:

1. A system for implementing optimized electronic routing of a direct benefit transfer payment from an originator payment account associated with an originator of the direct benefit transfer payment to a beneficiary payment account associated with a beneficiary of the direct benefit transfer payment, the system comprising:
a trusted intermediary platform server configured to function as a communication intermediate between (i) an originator bank server configured to initiate a direct benefit transfer payment from the originator payment account and (ii) a beneficiary bank server configured to receive electronic payments, wherein the trusted intermediary platform server comprises a processor programmed to:
receive, from the originator bank server, a user identifier uniquely associated with the beneficiary, and transaction amount information defining a transaction amount corresponding to the direct benefit transfer payment;
identify, based on a data record associated with the received user identifier, a payment account identifier that identifies the beneficiary payment account; and
route, to the beneficiary bank server, the payment account identifier and the transaction amount information.

2. The system as claimed in claim 1, wherein the processor is further programmed to:
receive, from a terminal device operated by the beneficiary, a request to enroll the beneficiary, the request to enroll the beneficiary comprising the user identifier and the payment account identifier, the user identifier having been generated by an identity verification platform and being associated in data records of the identity verification platform with identity information and biometric information corresponding to the beneficiary; and
generate the data record responsive to receipt of the request to enroll the beneficiary.

3. The system as claimed in claim 2, wherein to generate the data record, the processor is programmed to include, in the data record, the user identifier and the payment account identifier.

4. The system as claimed in claim 2, wherein the data record is generated subsequent to positive verification of an identity of the beneficiary by the identity verification platform.

5. The system as claimed in claim 1, wherein to identify the payment account identifier, the processor is programmed to:
retrieve, from a database, a plurality of data records associated with the received user identifier;
select the data record from among the plurality of data records associated with the received user identifier; and
extract, from the selected data record, at least the payment account identifier.

6. The system as claimed in claim 5, wherein the selection of the data record from among the plurality of data records is based on:
a received user input; or
a match between an originator identifier retrieved from the data record and an originator identifier associated with the originator of the direct benefit transfer payment.

7. A method for implementing optimized electronic routing of a direct benefit transfer payment from an originator payment account associated with an originator of the direct benefit transfer payment to a beneficiary payment account associated with a beneficiary of the direct benefit transfer payment, the method implemented at a processor of a trusted intermediary platform server configured to function as a communication intermediate between (i) an originator bank server configured to initiate a direct benefit transfer payment from an originator payment account, and (ii) a beneficiary bank server configured to receive electronic payments, the method comprising:
receiving, by the processor, from the originator bank server, a user identifier uniquely associated with the beneficiary, and transaction amount information defining a transaction amount corresponding to the direct benefit transfer payment;
identifying, by the processor, based on a data record associated with the received user identifier, a payment account identifier that identifies the beneficiary payment account; and
routing, by the processor, to the beneficiary bank server, the payment account identifier and the transaction amount information.

8. The method as claimed in claim 7, the method further comprising:
receiving, from a terminal device operated by the beneficiary, a request to enroll the beneficiary, the request to enroll the beneficiary comprising the user identifier and the payment account identifier, wherein the user identifier having been generated by an identity verification platform and being associated in data records of the identity verification platform with identity information and biometric information corresponding to the beneficiary; and
generating the data record responsive to receiving the request to enroll the beneficiary.

9. The method as claimed in claim 8, the method further comprising:
generating the data record to include the user identifier, and the payment account identifier.

10. The method as claimed in claim 8, wherein the data record is generated subsequent to positive verification of an identity of the beneficiary by the identity verification platform.

11. The method as claimed in claim 7, wherein identifying the payment account identifier, comprises:
retrieving, from a database, a plurality of data records associated with the received user identifier;
selecting the data record from among the plurality of data records associated with the received user identifier; and
extracting, from the selected data record, at least the payment account identifier.

12. The method as claimed in claim 11, wherein selecting the data record from among the plurality of data records associated with the received user identifier is based on:
a received user input; or
a match between an originator identifier retrieved from the data record and an originator identifier associated with the originator of the direct benefit transfer payment.

13. A computer readable medium for implementing optimized electronic routing of a direct benefit transfer payment from an originator payment account associated with an originator of the direct benefit transfer payment to a beneficiary payment account associated with a beneficiary of the direct benefit transfer payment, comprising a non-transitory computer usable medium having computer readable program code embodied therein, the computer readable program code comprising instructions that program a processor of a trusted intermediary platform server configured to function as a communication intermediate between (i) an originator bank server configured to initiate a direct benefit transfer payment from an originator payment account, and (ii) a beneficiary bank server configured to receive electronic payments, the processor programmed to:
receive, from the originator bank server, a user identifier uniquely associated with the beneficiary, and transaction amount information defining a transaction amount, corresponding to the direct benefit transfer payment;
identify, based on a data record associated with the received user identifier, a payment account identifier that identifies the beneficiary payment account that is associated with the beneficiary at a beneficiary bank; and
route, to the beneficiary bank server, the payment account identifier and the transaction amount information.

14. The computer readable medium of claim 13, wherein the computer readable program code further programs the processor to:
receive a request to enroll the beneficiary, the request to enroll the beneficiary comprising the user identifier and the payment account identifier; and
generate the data record to thereby enroll the beneficiary to receive direct benefit transfer payments to the beneficiary account identified by the payment account identifier.

15. The computer readable medium of claim 14, wherein the computer readable program code further programs the processor to:
verify validity of at least one of the user identifier and the payment account identifier, wherein the data record is generated based on the verified validity.

16. The computer readable medium of claim 14, wherein the request to enroll further comprises an originator identifier that identifies the originator, and wherein the computer readable program code further programs the processor to:
associate the payment account identifier and the originator identifier to indicate that the beneficiary payment account identified by the payment account identifier is to be used to receive the direct benefit transfer payment from the originator.

17. The computer readable medium of claim 16, wherein the computer readable program code further programs the processor to:
generate a second data record that associates a second payment account identifier of the beneficiary with a second originator identifier that identifies a second originator to indicate that a second beneficiary payment account identified by the second payment account identifier is to be used to receive the direct benefit transfer payment from the second originator.

18. The computer readable medium of claim 17, wherein the computer readable program code further programs the processor to:
receive, from a second originator bank server associated with the second originator, the user identifier and second transaction amount information defining a second transaction amount corresponding to a second direct benefit transfer payment;
identify, based on the second data record, the second payment account identifier; and
route, to a second beneficiary bank server associated with the second payment account identifier, the second payment account identifier and the second transaction amount information.

19. The computer readable medium of claim 13, wherein the user identifier is stored in association with a plurality of data records, each one of the plurality of data records including an identification of a respective account identifier of a respective beneficiary account of the beneficiary, each respective account identifier being linked to a respective originator identifier, and wherein the computer readable program code further programs the processor to:
select the data record from among the plurality of data records based on the user identifier and an originator identifier that identifies the originator of the direct benefit transfer payment to identify which one of the respective account identifiers is to be used to provide the direct benefit transfer payment from the originator.

20. The computer readable medium of claim 13, wherein the user identifier comprises a government-issued identifier assigned to the beneficiary to receive the direct benefit transfer payment.
